(19) United States
(12) Patent Application Publication
(10) Pub. No.: US 2015/0145384 A1
(43) Pub. Date: May 28, 2015

(54) APPARATUS AND METHOD FOR PROVIDING A SEAL AROUND A PERIMETER OF A BI-MATERIAL ENCLOSURE

(71) Applicant: MOTOROLA SOLUTIONS, INC, Schaumburg, IL (US)

(72) Inventors: KIOK YUNG LEE, NIBONG TEBAL (MY); CHEE KIT CHAN, IPOH (MY); BOON AIK EEO, BAYAN LEPAS (MY); WENG KONG HOR, BUTTERWORTH (MY); BAN HIN OOI, BAYAN LEPAS (MY); CLEMENT TOBIAS XAVIER PAKIAM, BATU FERRINGHI (MY)

(73) Assignee: MOTOROLA SOLUTIONS, INC., SCHAUMBURG, IL (US)

(21) Appl. No.: 14/089,035

(22) Filed: Nov. 25, 2013

(51) Int. Cl. H04M 1/02; B29C 45/14

(52) U.S. Cl. CPC H04M 1/0249; B29C 45/14; B29L 2031/3437
USPC 312/223.1; 264/259

(57) ABSTRACT

An enclosure includes a seal co-molded to a first material to form a sub-assembly in which the first material is securely adhered to the seal. The seal is designed to collapse in a specific direction during an injection molding process. The enclosure also includes a second material over-molded on the sub-assembly during the injection molding process. The seal is compressed in the specific direction during the injection molding process to produce a consistent wetting at least at one desired perimeter joint between the seal and the over-molded second material, forming the bi-material enclosure. The first material and the second material are dissimilar materials with different thermal expansion qualities.

### BACKGROUND OF THE INVENTION

Manufacturers of mobile devices are constantly working to make them thinner. One method used for making mobile devices thinner involves using a thinner material, for example, sheet metal for a housing/enclosure instead of or in addition to a typical thicker material, for example, plastic that is typically used for the enclosure. It is important, however, that thinner enclosures have the same strength as thicker enclosures. One avenue for maintaining the strength of an enclosure that includes thinner material is to over-mold a prefabricated thinner material, for example, the sheet metal to a thicker material, for example, a plastic enclosure. Consider an example where in a front housing keypad compartment of a mobile device the backing thickness for a plastic keypad bezel attached to a keypad Mylar stack up is reduced by over-molding the bezel and Mylar stack to a sheet metal instead of to a thicker plastic. In some instances, the thickness of the sheet metal may be 0.5 millimeters (mm) and the thickness of the plastic may be 1.2 mm, reducing the thickness of the enclosure by up to 58%. The process of over-molding two different materials with different thickness and properties (i.e., over-molding the prefabricated sheet metal to the plastic) is referred to herein as bi-material processing.

When a mobile device enclosure includes a thinner material over-molded to a thicker material, the enclosure must provide certain levels of protection as set forth in standards that cover enclosures for electrical equipment. For example, the IP Code, Ingress Protection Rating, as published by the International Electrotechnical Commission (IEC), classifies and rates the degree of protection mechanical casings with electrical components must provide against intrusions, dust, accidental contact and water. In particular, the IPX7 and IPX8 standards set forth the level of protection required of mechanical enclosures including electrical equipment against the ingress of water (referred to herein as the ingress protection requirement). For example, devices manufactured according to the IPX7 standard must be able to be immersed in up to 1 meter of water for thirty minutes without water entering through the enclosure, and devices manufactured according to the IPX8 standard must be able to be immersed in more than 1 meter of water for a period, as set by the manufacturer, which is greater than thirty minutes without water entering through the enclosure. Although enclosures created using bi-material process must satisfy the ingress protection requirement, after the materials are molded together, at the perimeter joints of the two materials, a leak path (i.e., a path through which water may travel to enter enclosure and reach internal electrical components) may exist. While the bi-material processing is used widely in the mobile device designs, current bi-material processes fail to provide a robust seal feature that integrates the two different materials and thereby provide adequate ingress protection.

Accordingly, there is a need for an apparatus and method of providing a seal around a perimeter of a bi-material enclosure.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A and 1B set forth cross-sectional views of an enclosure used in accordance with some embodiments.

FIG. 2A provides an isometric view of the enclosure used in accordance with some embodiments.

FIG. 2B is a diagram of a sub-assembly of in accordance with some embodiments.

FIGS. 3A-3C set forth cross sectional views of shapes of the high temperature seal before molding, after molding and during a temperature shock in accordance with some embodiments.

FIG. 4 sets forth steps implemented in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to methods and apparatuses for created in enclosure from a bi-material process. The enclosure includes a seal is co-molded to first material to form a sub-assembly in which the first material is securely adhered to the seal. The seal is designed to collapse in a specific direction during an injection molding process. The enclosure also includes a second material over-molded on the sub-assembly during the injection molding process. The seal is compressed in the specific direction during the injection molding process to produce a consistent wetting at least at one desired perimeter joint between the seal and the over-molded second material, forming the bi-material enclosure. The first material and the second material are dissimilar materials with different thermal expansion qualities.

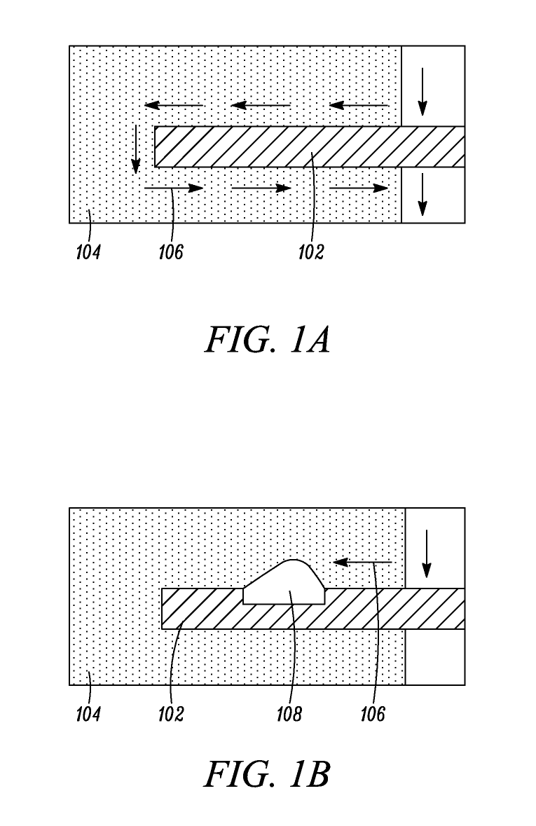

FIGS. 1A and 1B set forth cross-sectional views of an enclosure used in accordance with some embodiments. Enclosure 100 is created using a bi-material process, wherein a thicker material 104, for example plastic is over-molded to a thinner material 102, for example sheet metal, as shown in FIG. 1A. Thinner material 102 (also referred to as a first material 102 or simply material 102) and thicker material 104 (also referred to as a second material 104 or simply material 104) are dissimilar materials with different properties. For example, materials 102 and 104 may have different levels of thickness and different thermal expansion qualities. Enclosure 100 created using a bi-material process may be used, for example, in a keypad compartment, a speaker compartment, a battery compartment, a display compartment, and/or a front housing compartment of a portable radio.

Subsequent to thicker material 104 being over-molded to thinner material 102, when materials 102 and 104 are subjected to temperature cycles and shock, thermal expansion of thinner material 102 and thicker material 104 may occur. Over multiple temperature cycles, because of the inherent dissimilar coefficient of thermal expansion (CTE) of the materials 102 and 104, flaws in the joints between materials 102 and 104 may become obvious. In other words, over multiple temperature cycles, the joints of over-molded materials 102 and 104 may weaken due to thermal expansion of two dissimilar materials with dissimilar CTE. As the joint integrity between materials 102 and 104 is weakened by materials 102 and 104 being subjected to multiple temperature cycles and shock, there is a potential for water to leak into enclosure 100 through a leak path, as shown by arrows 106 or for a vacuum to form between materials 102 and 104.

In order to block leak path 106, a high temperature seal/gasket 108, for example, a high temperature silicon rubber is inserted in leak path 106, as shown in FIG. 1B. The material selected for high temperature seal 108 is one that can go through an injection molding process with temperatures up to 300 degrees Celsius and not melt. Accordingly, the softening temperature of high temperature seal 108 is higher than a resin processing temperature that is present during the injection molding process when a resin of thicker material 104 (for example, a plastic resin) is over-molded to a sub-assembly including thinner material 102 and high temperature seal 108. The material selected for high temperature seal 108 should also provide a required compression during high temperature shock when there is expansion between materials 102 and 104.

In an embodiment, high temperature seal 108 may be adhered securely to thinner material 102 using a co-molding process. After high temperature seal 108 is securely attached to thinner material 102, a thinner material 102/high temperature seal 108 sub-assembly is over-molded on to a plastic over-molding tool for a subsequent injection of resin of thicker material 104. The co-molding process secures any leak paths in the sub-assembly. During a subsequent injection molding process where, for example, a plastic resin is over-molded to the sub-assembly, high temperature seal 108 is compressed in a specific direction according to the resin flow front (due to the effect of the plastic flow in the injection molding) and wetting will occur between high temperature seal 108 and the newly over-molded plastic resin (i.e., the thicker material) to produce a secure seal between thinner material 102 and thicker material 104 and block any leak paths or vacuum from forming between materials 102 and 104.

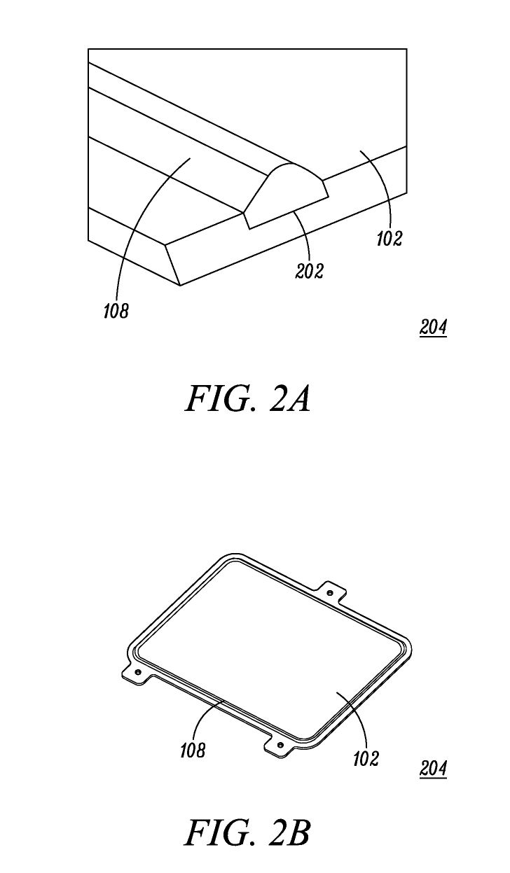

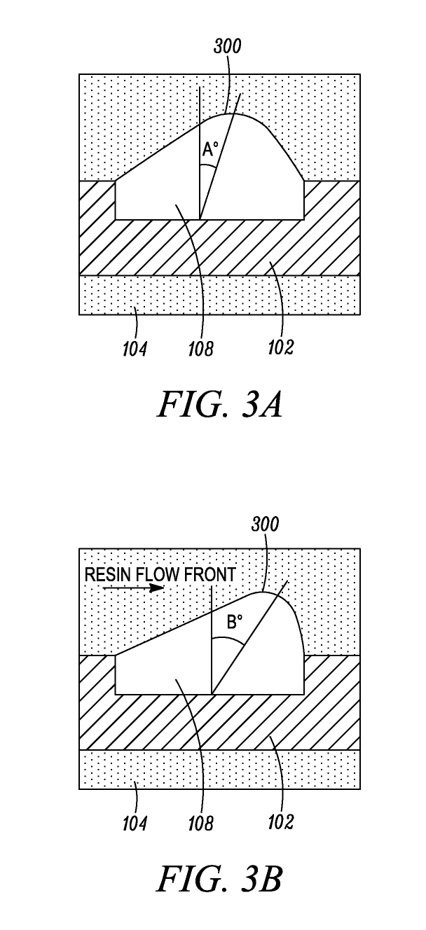

FIG. 2A provides an isometric view of the enclosure used in accordance with some embodiments. A groove 202 is etched with a micro pattern on to prefabricated thinner material 102 to enhance adhesion of high temperature seal 108 with thinner material 102. A thin layer of a primer, for example, glue, may be applied after the etching process to enhance the adhesion strength between thinner material 102 and high temperature seal 108. At a subsequent period, high temperature seal 108 is co-molded on groove 202 that has been etched on the prefabricated thinner material 102. During the subsequent over-molding process (not shown in FIG. 2A), resin of the thicker material 104 (for example, plastic resin) is over-molded to the thinner material 102/high temperature seal 108 sub-assembly 204. In an embodiment, the shape of high temperature seal 108 is not symmetrical to enable high temperature seal 108 to collapse more easily in a specific direction. FIG. 2B shows a further diagram of sub-assembly 204, wherein sub-assembly 204 as provided in FIG. 2B may be used in, for example, a battery compartment of a portable radio.

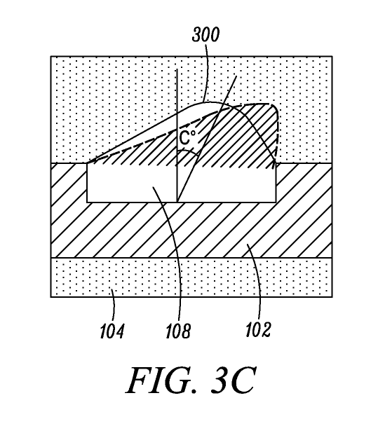

FIGS. 3A-3C set forth cross sectional views of shapes of the high temperature seal before molding, after molding and during a temperature shock in accordance with some embodiments. FIG. 3A shows how a rib 300 of high temperature seal 108 is positioned before the sub-assembly of the high temperature seal 108 and thinner material 102 is molded with the thicker material 104. Rib 300 of high temperature seal 108 is off centered, wherein the angle of rib 300 is denoted by A°. This ensures that rib 300 of high temperature seal 108 will collapse in a desired direction (i.e., the direction corresponding to the position of rib 300) during the injection molding process. If rib 300 of high temperature seal 108 were designed to be centered, the direction in which the rib would collapse during the injection molding process would not be properly defined.

During the molding process when a resin of thicker material 104 is over-molded to the sub-assembly of the high temperature seal 108 and thinner material 102, as the resin flows on to high temperature seal 108, it will deform in the direction of the flow of the resin. Non-symmetrical rib 300 of high temperature seal 108 will therefore enable high temperature seal 108 to collapse at one side when high temperature seal 108 is compressed by the resin flow front in the injection molding process, as shown in 3B. Accordingly, after the molding process, rib 300 of high temperature seal 108 will be further off-centered, wherein the angle of the rib is denoted by B°. Thereafter, during temperature shock cycles when there is thermal expansion of at least one of the over-molded thinner material 102 and thicker material 104, materials 102 and 104 will expand at the different rates. Rib 300 of high temperature seal 108 may become relaxed or restored closer to its original shape when, for example, the plastic (i.e., the thicker material 104) expands. The shape of rib 300 before rib 300 is restored closer to its original shape is denoted by the area within the dashed lines in FIG. 3C. Due to sufficient compression occurring between rib 300 of high temperature seal 108 and the plastic substrate when the plastic expands, rib 300 of high temperature seal 108 will adhere firmly to the plastic substrate during a temperature shock process and yield a bi-material enclosure that is sealed from water leaks and that does not include a vacuum, as shown in 3C. Accordingly, during temperature shock cycles, rib 300 of high temperature seal 108 moves closer to the center than it was after the molding process. The angle of the rib temperature shock cycles is denoted by C°, wherein B° is greater than C° which is greater than A°.

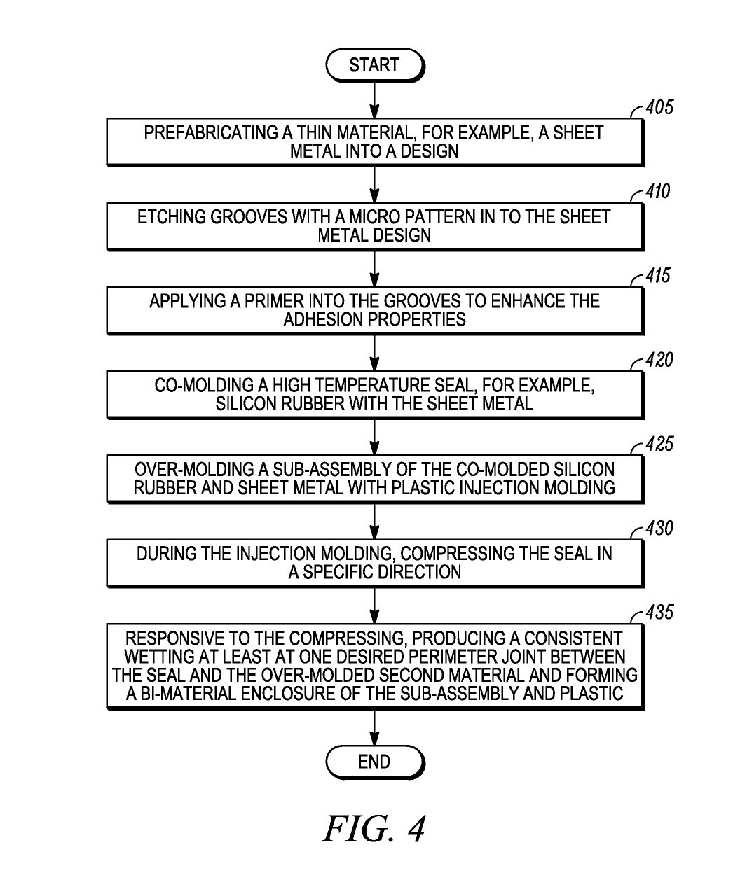

FIG. 4 sets forth steps implemented in accordance with some embodiments. At 405, prefabricating a thin material, for example, a sheet metal into a design. At 405, etching grooves with a micro pattern in to sheet metal design. At 415, applying a primer into the grooves to enhance the adhesion properties. At 420, co-molding a high temperature seal, for example, silicon rubber with the sheet metal. At 425, over-molding a sub-assembly of the co-molded silicon rubber and sheet metal with plastic injection molding. At 430, during the injection molding, compressing the seal in a specific direction. At 435, responsive to the compressing, producing a consistent at least at one desired perimeter joint between the seal and the over-molded second material and a bi-material enclosure is formed of the sub-assembly and plastic. This method therefore provides a secure seal between the sub-assembly and plastic to block any leak paths or vacuum from forming between the sub-assembly and plastic when the bi-material enclosure is exposed to temperature shock cycles.

Embodiments of methods and apparatuses disclosed herein provide a robust seal for an enclosure created from a bi-material process. The enclosure is created by over-molding a thicker material to a thinner material, thereby producing a significantly thinner enclosure. The seal blocks any leak paths or vacuum from forming between the thicker and thinner materials when the bi-material enclosure is exposed to temperature shock cycles. The seal therefore enables the bi-material enclosure to meet the ingress protection requirement as set forth, for example, in the IPX7 and IPX8 standards.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An enclosure, comprising;
a seal co-molded to a first material to form a sub-assembly in which the first material is securely adhered to the seal, wherein the seal is designed to collapse in a specific direction during an injection molding process; and
a second material over-molded on the sub-assembly during the injection molding process, wherein the seal is compressed in the specific direction during the injection molding process to produce a consistent wetting at least at one desired perimeter joint between the seal and the over-molded second material, forming a bi-material enclosure,
wherein the first material and the second material are dissimilar materials with different thermal expansion qualities.

2. The enclosure of claim 1, wherein the first material is thinner than the second material.

3. The enclosure of claim 1, wherein prior to the seal being co-molded to the first material, a groove is etched with a micro pattern on to a prefabrication of the first material to enhance adhesion of the seal to the first material.

4. The enclosure of claim 3, wherein a primer is applied after the groove is etched to the prefabrication of the first material but prior to the seal being co-molded to the first material, wherein when the seal is co-molded to the first material, the seal is co-molded on the groove.

5. The enclosure of claim 1, wherein prior to the injection molding process, a rib of the seal is positioned in one of a left position and right position and away from a center position and wherein the seal is designed to collapse during the injection molding process in a direction corresponding to the position of the rib.

6. The enclosure of claim 1, wherein a rib of the seal is designed to deform in a direction of a resin flow of the second material when the resin of the second material flows on the seal during the injection molding process.

7. The enclosure of claim 1, wherein a rib of the seal is designed to relax and adhere firmly to the second material during a temperature shock cycle when there is thermal expansion of at least one of the first material and the second material of the bi-material enclosure.

8. The enclosure of claim 1, wherein the specific direction is the direction of a resin flow of the second material during the injection molding process.

9. The enclosure of claim 1, wherein the seal is high temperature silicon rubber.

10. The enclosure of claim 1, wherein a softening temperature of the seal is higher than a resin processing temperature of a resin flow of the second material during the injection molding process.

11. A method, comprising;
co-molding a seal to a first material form a sub-assembly in which the first material is securely adhered to the seal, wherein the seal is designed to collapse in a specific direction during an injection molding process;
over-molding a resin flow of a second material on the sub-assembly during the injection molding process,
compressing the seal in the specific direction during the injection molding process;
responsive to the compressing, producing a consistent wetting at least at one desired perimeter joint between the seal and the over-molded second material; and
forming a bi-material enclosure,
wherein the first material and the second material are dissimilar materials with different thermal expansion qualities.

12. The method of claim 11, wherein prior to the co-molding, etching a groove with a micro pattern on to a prefabrication of the first material to enhance adhesion of the seal to the first material.

13. The method of claim 12, further comprising applying a primer after the groove is etched to the prefabrication of the first material but prior to the co-molding, wherein during co-molding of the seal to the first material, the seal is co-molded on the groove.

14. The method of claim 11, wherein prior to the injection molding process, positioning a rib of the seal in one of a left position and right position and away from a center position, wherein the seal is designed to collapse during the injection molding process in a direction corresponding to the position of the rib.

15. The method of claim 11, further comprising designing a rib of the seal to deform in a direction of the resin flow of the second material when the resin the second material flows on the seal during the injection molding process.

16. The method of claim 11, further comprising designing a rib of the seal to relax and adhere firmly to the second material during a temperature shock cycle when there is thermal expansion of at least one of the first material and the second material of the bi-material enclosure.

17. A bi-material enclosure of an electronic device, comprising;
a sub-assembly including a seal securely co-molded to a first material, wherein the seal is designed to collapse in a specific direction during an injection molding process; and
a second material configured to be over-molded on the sub-assembly during the injection molding process and compress the seal in the specific direction to produce a consistent wetting at least at one desired perimeter joint between the seal and the over-molded second material,
wherein the first material and the second material are dissimilar materials with different thermal expansion qualities.

18. The bi-material enclosure of claim 17, wherein the first material is thinner than the second material.

19. The bi-material enclosure of claim 17, wherein a groove is etched with a micro pattern on to a prefabrication of the first material to enhance adhesion of the seal to the first material.

20. The bi-material of claim 19, wherein a primer is applied after the groove is etched to the prefabrication of the first material but prior to the first material being co-molded to the seal, wherein when the first material is co-molded to the seal, the seal is co-molded on the groove.

21. The bi-material enclosure of claim 17, wherein a embedded gasket of the seal is positioned in one of a left position and right position and away from a center position and wherein the seal is designed to collapse during the injection molding process in a direction corresponding to the position of the embedded gasket.
